(19) United States
(12) Patent Application Publication
(10) Pub. No.: US 2024/0202502 A1
(43) Pub. Date: Jun. 20, 2024

(54) METHOD AND APPARATUS FOR GENERATING BOTH LOCAL-LEVEL AND GLOBAL-LEVEL EXPLANATIONS OF GRAPH NEURAL NETWORKS

(71) Applicant: Research Business Foundation SUNGKYUNKWAN UNIVERSITY, Suwon-si (KR)

(72) Inventors: Gyeong Rok PARK, Suwon-si (KR); Hogun PARK, Suwon-si (KR)

(73) Assignee: Research Business Foundation SUNGKYUNKWAN UNIVERSITY, Suwon-si (KR)

(21) Appl. No.: 18/507,276

(22) Filed: Nov. 13, 2023

(30) Foreign Application Priority Data
Dec. 14, 2022 (KR) 10-2022-0175115

(51) Int. Cl. G06N 3/0464

(52) U.S. Cl. CPC G06N 3/0464

(57) ABSTRACT

There is provided an apparatus of generating explanations for a graph neural network. The apparatus comprises the graph neural network that embeds an input graph into a node representation matrix H, and then outputs a result matrix Z in which a score of a specific class for each node is represented corresponding to the node representation matrix using a weight matrix W.

### TECHNICAL FIELD

The present disclosure relates to a method of generating explanations for a graph neural network and a device for performing the method.

This work was supported by National Research Foundation of Korea grant funded by the Korea government (MSIT; Ministry of Science and ICT) (No. 2021R1C1C1005407, A Study on Providing Explanations for Node Representation Learning Models), National Research Foundation of Korea (NRF) grant funded by the Korea government (MOE; Ministry of Education of the Republic of Korea) (the BK21 FOUR Project), National IT Industry Promotion Agency (NIPA) grant funded by the Korea government (MSIT) (No. S0254-22-1001, Development of brain-body interface technology using AI-based multi-sensing), National Research Foundation of Korea grant funded by the Korea government (MSIT) (No. 2021M3H4A1A02056037, Development of stress visualization and quantization based on strain sensitive smart polymer for building structure durability examination platform), and Institute of Information & communications Technology Planning & Evaluation (IITP) grant funded by Korea government (MSIT) (No. 2019-0-00421-004, AI Graduate School Support Program (Sungkyunkwan University)).

### BACKGROUND

Graph neural networks are receiving a lot of attention for their high performance in fields such as node classification, graph classification, and link prediction using graph data. Graph neural networks have a complex structure because they perform tasks by recursively aggregating and transferring information from multiple nodes. Due to such a complex structure within graph neural networks, it is difficult to analyze or interpret prediction of the graph neural networks. To overcome this, various methodologies for providing explanations for a graph neural network as subgraphs have been proposed.

However, since these methodologies present a subgraph composed of important edges in an input graph as a unit, there is a problem in that a subgraph in which structural information is lost may be presented. Moreover, the methodologies also have the disadvantage of not being able to provide global/local explanations at the same time.

### SUMMARY

According to an embodiment, a method and device for generating explanations for a graph neural network by using a graphlet that reflect structural information as a basic unit for analyzing a graph and using an orbit as a unit for explaining graph data as a component node of the graphlet are provided.

The aspects of the present disclosure are not limited to the foregoing, and other aspects not mentioned herein will be clearly understood by those skilled in the art from the following description.

In accordance with an aspect of the present disclosure, there is provided a method of generating explanations for a graph neural network to be performed by an apparatus for generating explanations for the graph neural network, the method comprises: preparing the graph neural network that embeds an input graph into a node representation matrix H, and then outputs a result matrix Z in which a score of a specific class for each node is represented corresponding to the node representation matrix using a weight matrix W′; decomposing the weight matrix W into vector products of an orbit weight matrix P containing information on each orbit and an orbit-class score matrix S; generating a global explanation in which corresponding orbits and graphlets including the corresponding orbits are provided as subgraphs of the input graph in descending order of orbit-class scores indicating contributions of orbits when the graph neural network classifies nodes into a specific class on the basis of results of decomposition; selecting a specific node among nodes and classifying the selected specific node as the specific class; and generating a local explanation in which corresponding orbits and graphlets including the corresponding orbits are provided as subgraphs of the input graph in descending order of node-orbit-class scores indicating contributions of nodes when the graph neural network classifies the selected specific node as the specific class on the basis of the results of decomposition.

The decomposing may include training the orbit weight matrix P using each node embedding vector in the input graph as an input such that presence or absence of a specific orbit for each node is predictable using a vector product of each node embedding vector and an orbit weight vector; and training orbit-class scores using the trained orbit weight matrix P as an input such that the weight matrix W is able to be restored using a matrix product of the orbit weight matrix P and the orbit-class score matrix S.

The training of the orbit weight matrix P may include calculating the vector product for all node embedding vectors in the input graph, applying a sigmoid function to the vector product, and then training a case in which a specific orbit exists at a corresponding node as 1 and a case in which the specific orbit does not exist at the corresponding node as 0; and normalizing the trained orbit weight vector in order to obtain an orbit weight vector of a certain size to train a final orbit weight vector containing orbit distribution information.

The training of the orbit-class scores may include training coefficients when a weight vector is decomposed into linear combinations of orbit weights.

The orbit-class score is limited to positive numbers at the time of training the coefficients.

The training orbit-class scores is performed such that differences from the weight vector are reduced by selecting orbit weights one by one.

In accordance with another aspect of the present disclosure, there is provided an apparatus for generating explanations for a graph neural network, the apparatus comprises: a memory configured to store one or more instructions; and a processor configured to execute the one or more instructions stored in the memory, wherein the instructions, when executed by the processor, cause the processor to prepare the graph neural network that embeds an input graph into a node representation matrix H, and then outputs a result matrix Z in which a score of a specific class for each node is represented corresponding to the node representation matrix using a weight matrix W; decompose the weight matrix W into vector products of an orbit weight matrix P containing information on each orbit and an orbit-class score matrix S; generate a global explanation in which corresponding orbits and graphlets including the corresponding orbits are provided as subgraphs of the input graph in descending order of orbit-class scores indicating contributions of orbits when the graph neural network classifies nodes into a specific class on the basis of results of decomposition; select a specific node among nodes and classify the selected specific node as the specific class; and generate a local explanation in which corresponding orbits and graphlets including the corresponding orbits are provided as subgraphs of the input graph in descending order of node-orbit-class scores indicating contributions of nodes when the graph neural network classifies the selected specific node as the specific class on the basis of the results of decomposition.

The processor may be configured to train the orbit weight matrix P using each node embedding vector in the input graph as an input such that presence or absence of a specific orbit for each node is predictable using a vector product of each node embedding vector and an orbit weight vector; and train orbit-class scores using the trained orbit weight matrix P as an input such that the weight matrix W is able to be restored using a matrix product of the orbit weight matrix P and the orbit-class score matrix S.

The processor may be configured to: calculate the vector product for all node embedding vectors in the input graph, apply a sigmoid function to the vector product, and then train a case in which a specific orbit exists at a corresponding node as 1 and a case in which the specific orbit does not exist at the corresponding node as 0; and normalize the trained orbit weight vector in order to obtain an orbit weight vector of a certain size to train a final orbit weight vector containing orbit distribution information.

The processor may be configured to train coefficients when a weight vector is decomposed into linear combinations of orbit weights at the time of training the orbit-class scores.

The orbit-class score may be limited to positive numbers at the time of training the coefficients.

The processor may be configured to train the coefficients such that differences from the weight vector are reduced by selecting orbit weights one by one.

In accordance with another aspect of the present disclosure, there is provided a non-transitory computer-readable recording medium storing a computer program, which comprises instructions for a processor to perform a method of generating explanations for a graph neural network, the method comprise: preparing the graph neural network that embeds an input graph into a node representation matrix H, and then outputs a result matrix Z in which a score of a specific class for each node is represented corresponding to the node representation matrix using a weight matrix W′; decomposing the weight matrix W into vector products of an orbit weight matrix P containing information on each orbit and an orbit-class score matrix S; generating a global explanation in which corresponding orbits and graphlets including the corresponding orbits are provided as subgraphs of the input graph in descending order of orbit-class scores indicating contributions of orbits when the graph neural network classifies nodes into a specific class on the basis of results of decomposition; selecting a specific node among nodes and classifying the selected specific node as the specific class; and generating a local explanation in which corresponding orbits and graphlets including the corresponding orbits are provided as subgraphs of the input graph in descending order of node-orbit-class scores indicating contributions of nodes when the graph neural network classifies the selected specific node as the specific class on the basis of the results of decomposition.

According to an embodiment, interpretation and understanding of graph neural network prediction are facilitated by providing a subgraph using a graphlet that reflects structural information as a basic unit for analyzing a graph and using an orbit as a unit for explaining graph data as a component node of the graphlet as an explanation. Moreover, both global and local explanations are provided to enable interpretation and understanding of graph neural network prediction from various perspectives.

### BRIEF DESCRIPTION OF THE DRAWINGS

FIG. 1 shows graphlets and orbits to be used as explanation units in a graph neural network explanation generation method and device according to an embodiment of the present disclosure.

FIG. 2 shows an example in which the presence or absence of orbits #0 to #3 for each node is indicated in graph data input to a graph encoder of a graph neural network.

FIG. 3 is a configuration diagram of a computer device capable of functioning as a graph neural network explanation generation device capable of performing a graph neural network explanation generation method according to an embodiment of the present disclosure.

FIG. 4 is a conceptual diagram illustrating the graph neural network explanation generation method according to an embodiment of the present disclosure.

FIG. 5 is a flowchart illustrating the graph neural network explanation generation method according to an embodiment of the present disclosure.

FIG. 6 is a flowchart illustrating an orbit weight training process in the graph neural network explanation generation method according to an embodiment of the present disclosure.

FIG. 7 is a flowchart illustrating an orbit-class score training process in the graph neural network explanation generation method according to an embodiment of the present disclosure.

FIG. 8 shows a process through which each class weight is decomposed into linear combinations of orbit weight vectors and orbit-class scores.

FIG. 9 shows an example of a global explanation and a local explanation according to the graph neural network explanation generation method according to an embodiment of the present disclosure.

FIG. 10 shows important motifs of a data set of ‘ba-shapes’.

### DETAILED DESCRIPTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

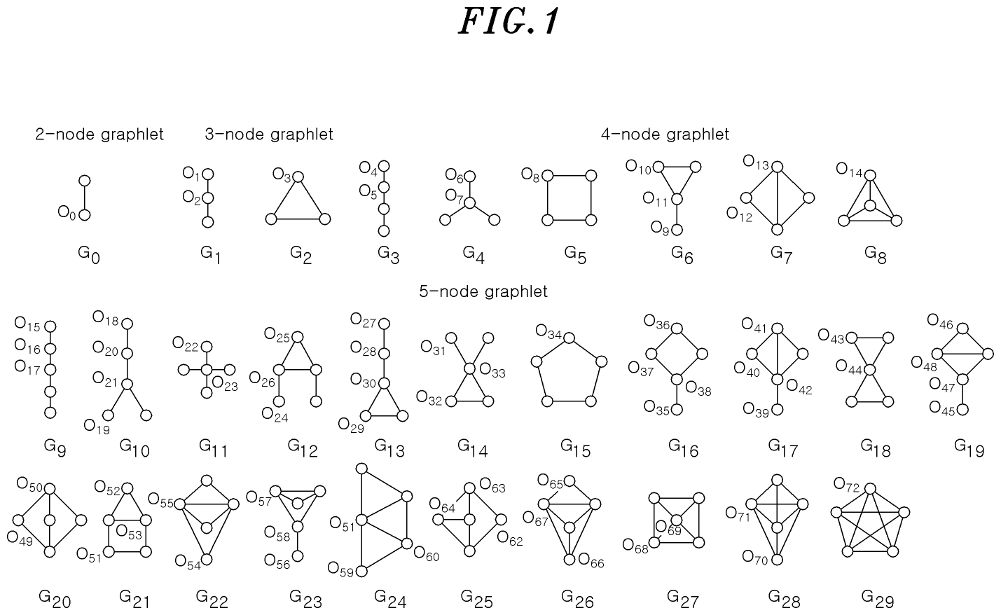

FIG. 1 shows graphlets and orbits to be used as explanation units in a graph neural network explanation generation method and device according to an embodiment of the present disclosure. An 1-th graphlet is denoted by Gₗ, a k-th orbit is denoted by oₖ, and the total number of orbits is denoted by K.

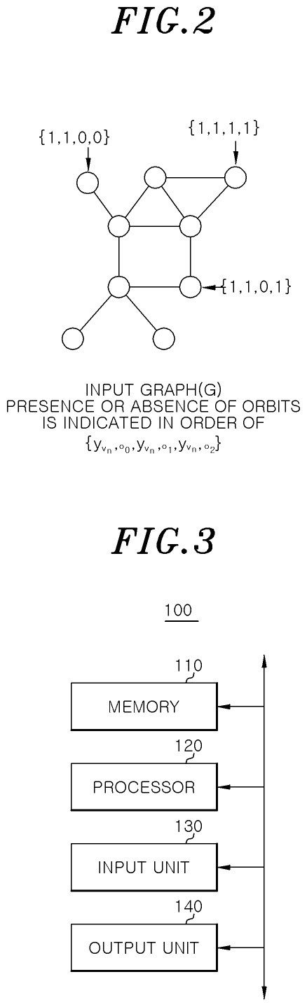

FIG. 2 shows an example in which the presence or absence of orbits 0-3 for each node is indicated in graph data input to a graph encoder of a graph neural network. An n-th node of an input graph is denoted by vₙ, and the total number of nodes is denoted by N. The presence or absence of the orbit oₖ of vₙ is indicated by yᵥ_{ₙ}_{,o}_{ₖ}. ‘1’ indicates that an orbit exists at a corresponding node, and ‘0’ indicates that an orbit does not exist at a corresponding node.

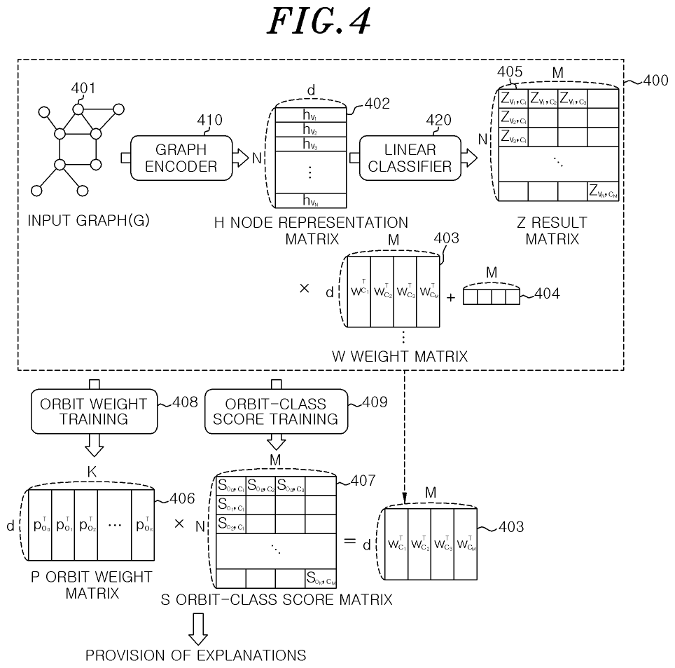

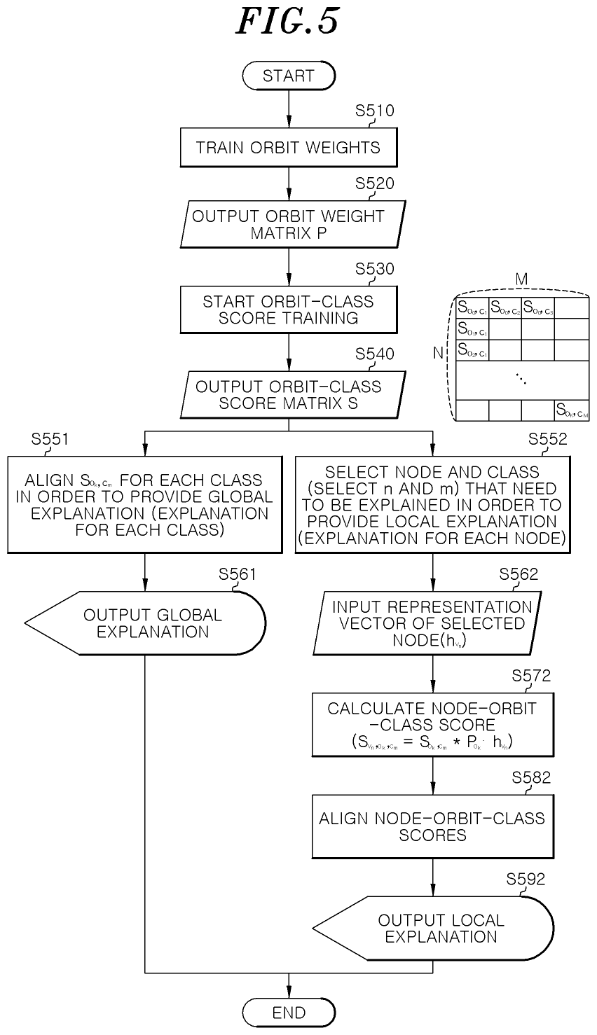

FIG. 3 is a configuration diagram of a computer device capable of functioning as a graph neural network explanation generation device capable of performing a graph neural network explanation generation method according to an embodiment of the present disclosure, and FIG. 4 is a conceptual diagram illustrating the graph neural network explanation generation method according to an embodiment of the present disclosure.

Referring to FIGS. 3 and 4, the computer device 100 includes a memory 110 and a processor 120 and may further include an input unit 130 and/or an output unit 140. However, the configuration diagram shown in FIG. 3 is merely illustrative, and the spirit of the present invention is not limited to the configuration diagram shown in FIG. 3. For example, the computer device 100 may include at least one component that is not shown in FIG. 3 or may not include at least one component shown in FIG. 3.

The memory 110 can be implemented using media that stores information. Such media include, but are not limited to, a ROM and a RAM. The memory 110 stores data or at least one instruction executable by the processor 120 which will be described below. Additionally, the memory 110 may store a computer program that causes the processor 120 to perform a graph neural network explanation generation method.

The processor 120 can be implemented by a processing device having at least one core. For example, the processor 120 may include at least one CPU or GPU. This processor 120 can read the above-described data or instructions stored in the memory 110 and can write new data or instructions to the memory 110. Further, the processor 120 can modify or delete already recorded data or instructions.

The computer device 100 can perform various functions through the processor 120. For example, the computer device 100 can perform a graph neural network explanation generation method.

A graph neural network 400 for which the processor 120 of the computer device 100 can generate explanations using a graphlet that reflects structural information as a basic unit for analyzing a graph and using an orbit as a unit for explaining graph data as a component node of the graphlet includes a graph encoder 410 and a linear classifier 420.

The graph encoder 410 embeds an input graph (G) 401 input thereto into a node representation matrix (H) 402.

The linear classifier 420 outputs a result matrix (Z) 405 in which a score of a specific class for each node is represented in response to the node representation matrix (H) 402 using a weight matrix (W) 403. The linear classifier 420 may derive the result matrix (Z) 405 by performing a vector product operation on the node representation matrix (H) 402 and the weight matrix (W) 403 and then performing a vector sum operation on the result of the vector product operation and a bias (b) 404.

In order to generate explanations for this graph neural network 400, the processor 120 decomposes the weight matrix (W) 403 into vector products of an orbit weight matrix (P) 406 containing information on each orbit and an orbit-class score matrix (S) 407. To this end, the processor 120 needs to train orbit weights in advance (408) and train orbit-class scores in advance (409). This training process will be described in detail below.

In addition, the processor 120 generates and provides a global explanation in which corresponding orbits and graphlets including the corresponding orbits are provided as subgraphs of the input graph (G) 401 in descending order of orbit-class scores indicating contributions of orbits when the graph neural network 400 classifies nodes into a specific class on the basis of the result of decomposition of the weight matrix (W) 403. Further, the processor 120 generates and provides a local explanation in which corresponding orbits and graphlets including the corresponding orbits are provided as subgraphs of the input graph (G) 401 in descending order of node-orbit-class scores indicating contribution of nodes when the graph neural network 400 classifies the specific node as the specific class on the basis of the result of decomposition of the weight matrix (W) 403.

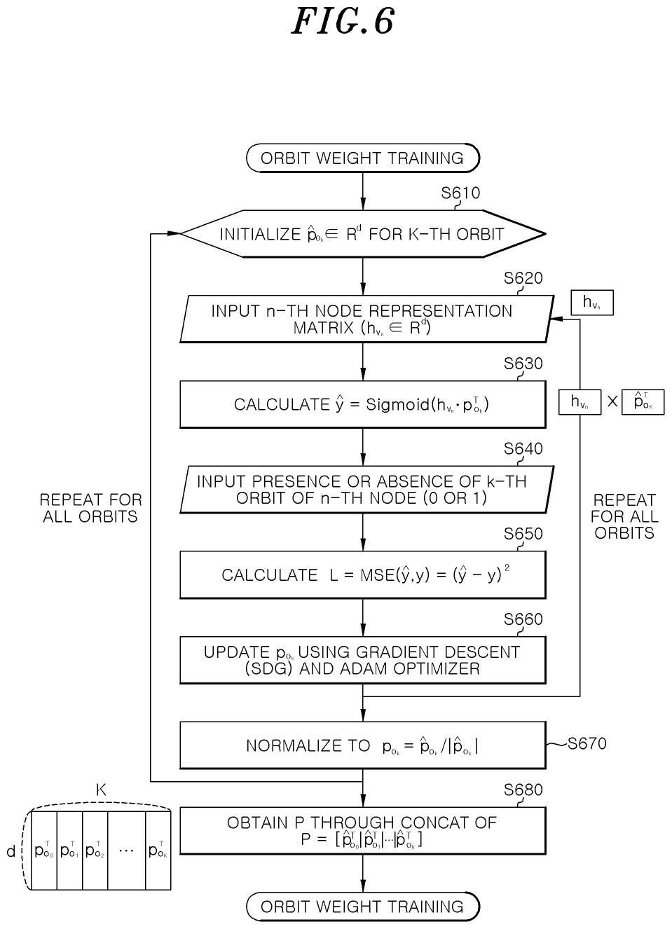

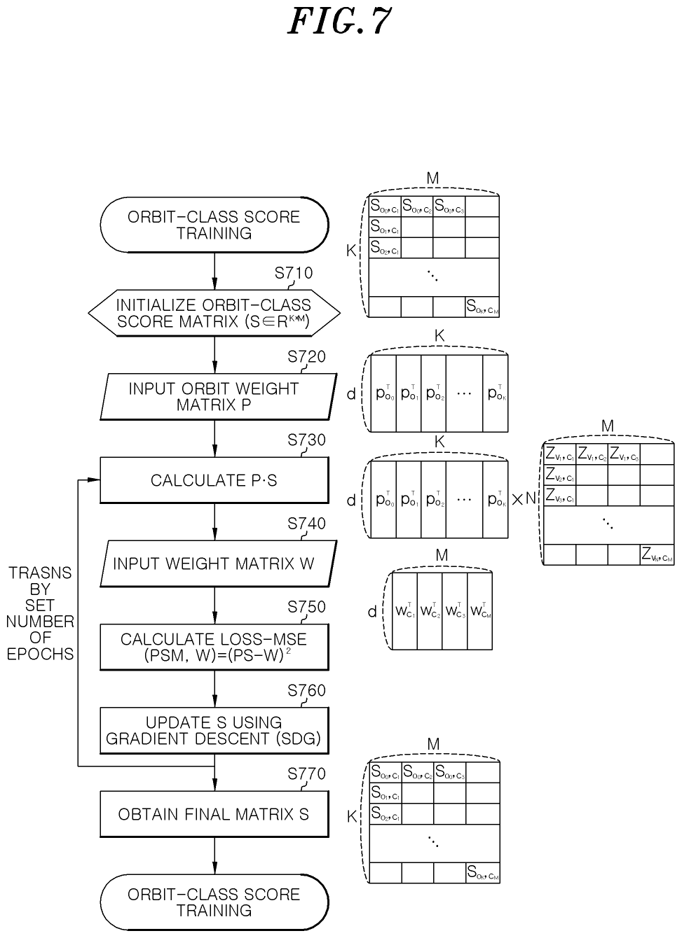

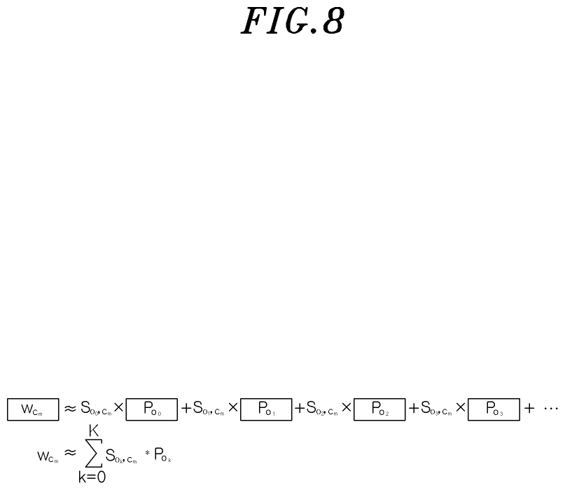

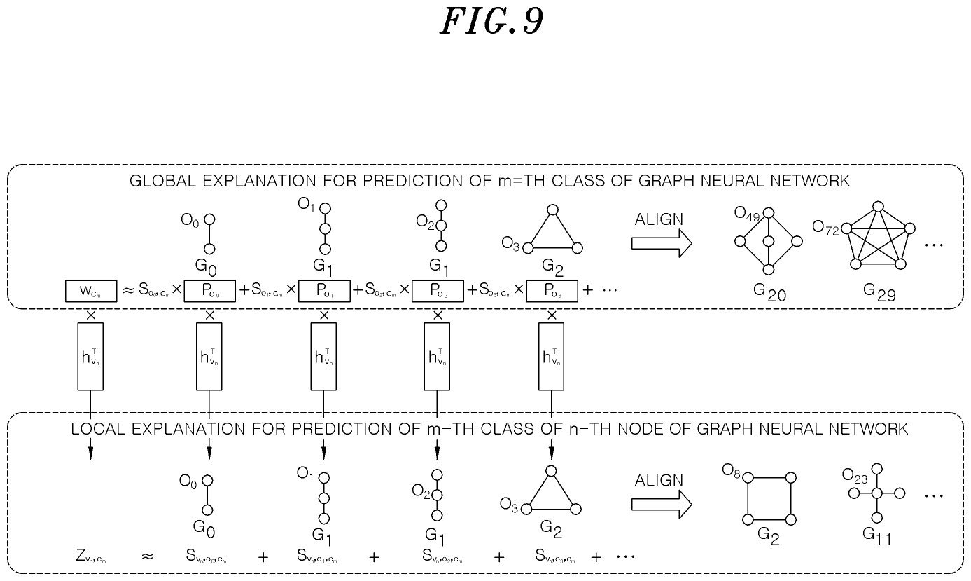

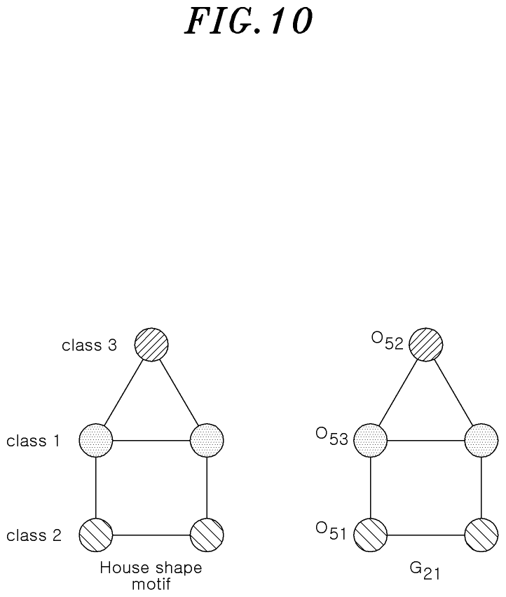

FIG. 5 is a flowchart illustrating the graph neural network explanation generation method according to an embodiment of the present disclosure, FIG. 6 is a flowchart illustrating an orbit weight training process in the graph neural network explanation generation method according to an embodiment of the present disclosure, and FIG. 7 is a flowchart illustrating an orbit-class score training process in the graph neural network explanation generation method according to an embodiment of the present disclosure. FIG. 8 shows a process through which each class weight is decomposed into linear combinations of an orbit weight vector and orbit-class scores. FIG. 9 shows an example of a global explanation and a local explanation according to the graph neural network explanation generation method according to an embodiment of the present disclosure. FIG. 10 shows important motifs of a data set of ‘ba-shapes’.

Hereinafter, the graph neural network explanation generation method performed by the computer device 100 functioning as the graph neural network explanation generation device according to an embodiment of the present disclosure will be described in detail with reference to FIGS. 3 to 10.

The processor 120 of the computer device 100 is used to generate explanations for the graph neural network 400 described with reference to FIG. 4.

The linear classifier 420 of the graph neural network 400 needs to decompose the weight matrix (W) 403 used to output the result matrix (Z) 405 corresponding to the node representation matrix (H) 402 into vector products of the orbit weight matrix (P) 406 containing information on each orbit and the orbit-class score matrix (S) 407.

FIG. 8 shows a process through which each class weight w_{c}_{ₙ} is decomposed into linear combinations of orbit weight vectors P_{O}_{ₓ} and orbit-class scores S_{O}_{ᵥ}_{,c}_{ₘ}. An m-th class is denoted by Cₘ, and the total number of classes is denoted by M. The orbit weight vector is expected to contain information on an orbit distribution of an input graph for each orbit. An orbit-class score refers to a coefficient when a class weight is decomposed into orbit weight vectors and indicates a degree to which each orbit weight vector contributes to restoration of the class weight. That is, it indicates the degree to which each orbit contributes to a class in a graph neural network and refers to a global explanation.

In addition, for such decomposition, the processor 120 needs to train orbit weights in advance (408) and train orbit-class scores in advance (409).

Referring to the flowchart of FIG. 5, the processor 120 trains an obit weight matrix P using each node embedding vector in an input graph as an input such that the presence or absence of a specific orbit for each node can be predicted with a vector product with an orbit weight vector. Here, the processor 120 calculates vector products for all node embedding vectors in the input graph, applies a sigmoid function to the result, and then trains presence of a specific orbit at a corresponding node as 1 and absence of the specific orbit at the corresponding node as 0 (S510). Then, the processor 120 normalizes the train ed orbit weight vectors to obtain an orbit weight vector of a certain size, trains a final orbit weight vector containing orbit distribution information, and outputs the weight matrix P containing information on each orbit (S520).

Steps S510 and S520 will be described in more detail with reference to FIG. 6. The weight vector \hat{P}_{O}_{ₓ} of the k-th orbit is initialized (S610).

Then, the vector product h_{V}_{ₙ}\hat{P}_{O}_{ₖ}^{T} of the n-th node embedding vector h_{V}_{ₙ} and the weight vector of the k-th orbit is calculated (S620 and S630). Subsequently, a sigmoid function is applied to the value of the calculated vector product, and then a squared error with respect to the presence or absence of the k-th orbit of the n-th node is obtained to calculate a loss Loss=(y_{V}_{ₙ}_{,O}_{ₖ}−h_{V}_{ₙ}\hat{P}_{O}_{ₖ}^{T})² (S640 and S650). Thereafter, the orbit weight vector is updated using gradient descent (S660). This orbit weight vector update process from steps S620 to S660 is repeated for all nodes.

Subsequently, in order to fix the size of the orbit weight vector to 1, normalization P_{O}_{ₖ}=\hat{P}_{O}_{ₖ}^{T}/|\hat{P}_{O}_{ₖ}^{T}| for dividing the trained orbit weight vector by the size of the vector is performed to obtain the final k-th orbit weight vector \hat{P}_{O}_{ₓ} (S670).

By repeating the initialization step S610 to the normalization step S670 performed on a weight vector \hat{P}_{O}_{ₓ} of a predetermined orbit for all orbits, the orbit weight matrix P is obtained (S680).

Referring back to FIG. 5, the processor 120 takes the trained orbit weight matrix P as an input, trains orbit-class scores such that the weight matrix W can be restored with a matrix product with an orbit-class score matrix S, and outputs the orbit-class score matrix S is output (S530 and S540). Here, the processor 120 can train coefficients when the weight vector is decomposed into linear combinations of orbit weights. Additionally, when the processor 120 trains the coefficients, an orbit class score vector may be limited to positive numbers. The processor 120 may select orbit weights one by one for training to reduce differences with the weight vector.

Steps S530 and S540 will be described in more detail with reference to FIG. 7. The orbit-class score matrix S is initialized (S710).

Then, the matrix product PS of the orbit weight matrix P and the orbit-class score matrix S is calculated (S720 and S730). Subsequently, a loss is calculated (Loss=MSE(PS, W)) using the mean squared error of differences between the calculated matrix product PS and the weight matrix W (S740 and S750). Thereafter, the loss is updated using gradient descent (S760).

The process of calculating the matrix product PS in step S730 to the process of updating the loss in step S760 are repeated by a set number of epochs to obtain the final orbit-class score matrix S (S770).

Referring back to FIG. 5, the processor 120 generates a global explanation in which corresponding orbits and graphlets including the corresponding orbits are provided as subgraphs of the input graph (G) 401 in descending order of orbit-class scores indicating contributions of orbits when the graph neural network 400 classifies nodes into a specific class on the basis of the result of decomposition of the weight matrix W in steps S510 to S540 and provides the global explanation as illustrated in FIG. 9 (S551 and S561). The weight vector W_{c}_{ₘ} of the m-th class can be restored as the sum of products of the weight vector P_{O}_{ₓ} of each orbit and orbit-class scores S_{O}_{ₖ}_{,c}_{ₘ}. A explanation of the math class prediction can be provided through the orbit-class score S_{O}_{ₖ}_{,c}_{ₘ}. [Align] means alignment in order of size of orbit-class scores S_{O}_{ₖ}_{,c}_{ₘ}. Finally, corresponding orbits and graphlets including the corresponding orbits can be provided as subgraphs in descending order of orbit-class scores.

In addition, the processor 120 generates a local explanation in which corresponding orbits and graphlets including the corresponding orbits are provided as subgraphs of the input graph (G) 401 in descending order of node-orbit-class scores indicating contribution of nodes when the graph neural network 400 classifies a specific node as a specific class on the basis of the result of decomposition of the weight matrix W in step S510 to S540 and provides the local explanation as illustrated in FIG. 9 (S552, S562, S572, S582 and S592). FIG. 9 shows a process of providing a local explanation of prediction for the m-th class of the n-th node of the graph neural network. The prediction result Z_{V}_{ₙ}_{,c}_{ₘ} for the n-th node and the m-th class can be restored as the vector product W_{c}_{ₘ}h_{V}_{ₙ}^{T} of the math class vector and the n-th node embedding vector h_{V}_{ₙ}^{T}. Prediction for the m-th class of the n-th node can be provided through a node-orbit-class score S_{V}_{ₙ}_{,O}_{ₖ}_{,c}_{ₘ}. The node-orbit-class score S_{V}_{ₙ}_{,O}_{ₖ}_{,c}_{ₘ} can be represented as a product S_{V}_{ₙ}_{,O}_{ₖ}_{,c}_{ₘ}=S_{O}_{ₖ}_{,c}_{ₘ}*P_{O}_{ₖ}h_{V}_{ₙ}^{T} of the vector product of the k-th orbit weight vector and the n-th node embedding vector and the orbit-class score. [Align] means alignment in order of size of node-orbit-class scores S_{V}_{ₙ}_{,O}_{ₖ}_{,c}_{ₘ}. Finally, corresponding orbits and graphlets including the corresponding orbits can be provided as subgraphs in descending order of node-orbit-class scores.

FIG. 10 shows important motifs of a data set of ‘ba-shapes’. The ba-shapes data set is a data set in which random edges and nodes are attached to marked motifs. Each node color represents a ground truth answer class for a node classification task, a marked orbit represents a ground truth orbit for each class, and a marked graphlet represents a ground truth graphlet for each class.

The graph neural network used for description is a graph convolution network (GCN). Information obtained from training of the neural network on the ba-shapes data set is shown in Table 1 below.

TABLE 1

| Number of graph | Training | | Dimension of | Final |
|---|---|---|---|---|
| convolution layers | rate | Epoch | hidden state | accuracy |
| 3 | 0.001 | 1000 | 10 | 0.98 |

The explanation results of the global stage are shown in Table 2.

TABLE 2

| | Class (ground truth orbit) | | |
|---|---|---|---|
| | 1(o₅₃) | 2(o₅₁) | 3(o₅₂) |
| 1 | o₅₃(0.558) | o₅₁(0.737) | o₅₂(0.736) |
| 2 | o₃(0.228) | o₂₆(0.262) | o₂₂(0.253) |
| 3 | o₂(0.213) | o₂₇(0.0004) | o₄₂(0.00006) |

The leftmost row indicates the order of high orbit-class scores.

The content of each block of the table indicates Oₖ(S_{O}_{ₖ}_{,c}_{ₘ}).

All ground truth orbits of each class were presented as explanations with the highest orbit in the explanation results of the global stage.

The explanation results of the local stage are shown in Table 3. Representative graph neural network explanation models, GNNExplianer and PGExplainer, were used as comparison baselines.

TABLE 3

| | Model of present | | |
|---|---|---|---|
| | disclosure | GNNExplainer | PGExplainer |
| Accuracy | 0.9947 | 0.1314 | 0.1632 |
| Recall | 0.9971 | 0.7328 | 0.7953 |
| Fidelity | 0.6392 | 0.3802 | 0.5131 |

Accuracy is calculated by setting the ground truth graphlet G₂₁ as a ground truth in the local level explanation and setting a subgraph explanation presented by each explanation model as predicted values.

Recall is calculated by setting the edges in the ground true graphlet as ground truth and setting the edges of subgraphs presented by each explanation model as predicted values.

Fidelity is a difference value between a ground truth class of a node and a prediction result f(G-Gs) of a graph neural network f(x) when a graph G-Gs obtained by removing a prediction result f(G) of the graph neural network f(x) for ground truth classes of nodes and subgraphs Gs presented by explanations from an input graph G is used as an input graph, and is represented as f(G)-f(G-Gs).

It can be ascertained that the model of the present disclosure has superior performance in all indicators.

As described above, according to one embodiment of the present disclosure, interpretation and understanding of graph neural network prediction are facilitated by providing a subgraph using a graphlet that reflects structural information as a basic unit for analyzing a graph and using an orbit as a unit for explaining graph data as a component node of the graphlet as explanations. Moreover, both global and local explanations are provided to enable interpretation and understanding of graph neural network prediction from various perspectives.

The respective steps included in the graph neural network explanation generation method performed by the graph neural network explanation generation device according to the above-described embodiment may be implemented by a computer program recorded on a recording medium including instructions causing the processor to perform the steps.

In addition, the respective steps included in the graph neural network explanation generation method performed by the graph neural network explanation generation device according to the above-described embodiment may be implemented in a computer-readable recording medium in which a computer program including instructions causing the processor to perform the steps is recorded.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A method of generating explanations for a graph neural network to be performed by an apparatus for generating explanations for the graph neural network, the method comprising:
preparing the graph neural network that embeds an input graph into a node representation matrix H, and then outputs a result matrix Z in which a score of a specific class for each node is represented corresponding to the node representation matrix using a weight matrix W;
decomposing the weight matrix W into vector products of an orbit weight matrix P containing information on each orbit and an orbit-class score matrix S;
generating a global explanation in which corresponding orbits and graphlets including the corresponding orbits are provided as subgraphs of the input graph in descending order of orbit-class scores indicating contributions of orbits when the graph neural network classifies nodes into a specific class on the basis of results of decomposition;
selecting a specific node among nodes and classifying the selected specific node as the specific class; and
generating a local explanation in which corresponding orbits and graphlets including the corresponding orbits are provided as subgraphs of the input graph in descending order of node-orbit-class scores indicating contributions of nodes when the graph neural network classifies the selected specific node as the specific class on the basis of the results of decomposition.

2. The method of claim 1, wherein the decomposing includes:
training the orbit weight matrix P using each node embedding vector in the input graph as an input such that presence or absence of a specific orbit for each node is predictable using a vector product of each node embedding vector and an orbit weight vector; and
training orbit-class scores using the trainned orbit weight matrix P as an input such that the weight matrix W is able to be restored using a matrix product of the orbit weight matrix P and the orbit-class score matrix S.

3. The method of claim 2, wherein the trainof the orbit weight matrix P includes:
calculating the vector product for all node embedding vectors in the input graph, applying a sigmoid function to the vector product, and then training a case in which the specific orbit exists at a corresponding node as 1 and a case in which the specific orbit does not exist at the corresponding node as 0; and
normalizing the trained orbit weight vector in order to obtain an orbit weight vector of a certain size to train a final orbit weight vector containing orbit distribution information.

4. The method of claim 2, wherein the training of the orbit-class scores comprises training coefficients when a weight vector is decomposed into linear combinations of orbit weights.

5. The method of claim 4, wherein the orbit-class score is limited to positive numbers at the time of training the coefficients.

6. The method of claim 4, wherein the training orbit-class scores is performed such that differences from the weight vector are reduced by selecting orbit weights one by one.

7. An apparatus for generating explanations for a graph neural network, the apparatus comprising:
a memory configured to store one or more instructions; and
a processor configured to execute the one or more instructions stored in the memory, wherein the instructions, when executed by the processor, cause the processor to:
prepare the graph neural network that embeds an input graph into a node representation matrix H, and then outputs a result matrix Z in which a score of a specific class for each node is represented corresponding to the node representation matrix using a weight matrix W;
decompose the weight matrix W into vector products of an orbit weight matrix P containing information on each orbit and an orbit-class score matrix S;
generate a global explanation in which corresponding orbits and graphlets including the corresponding orbits are provided as subgraphs of the input graph in descending order of orbit-class scores indicating contributions of orbits when the graph neural network classifies nodes into a specific class on the basis of results of decomposition;
select a specific node among nodes and classify the selected specific node as the specific class; and
generate a local explanation in which corresponding orbits and graphlets including the corresponding orbits are provided as subgraphs of the input graph in descending order of node-orbit-class scores indicating contributions of nodes when the graph neural network classifies the selected specific node as the specific class on the basis of the results of decomposition.

8. The apparatus of claim 7, wherein the processor is configured to:
train the orbit weight matrix P using each node embedding vector in the input graph as an input such that presence or absence of a specific orbit for each node is predictable using a vector product of each node embedding vector and an orbit weight vector; and
train orbit-class scores using the trained orbit weight matrix P as an input such that the weight matrix W is able to be restored using a matrix product of the orbit weight matrix P and the orbit-class score matrix S.

9. The apparatus of claim 8, wherein, when training the orbit weight matrix P, the processor is configured to:
calculate the vector product for all node embedding vectors in the input graph, apply a sigmoid function to the vector product, and then train a case in which a specific orbit exists at a corresponding node as 1 and a case in which the specific orbit does not exist at the corresponding node as 0; and
normalize the trained orbit weight vector in order to obtain an orbit weight vector of a certain size to train a final orbit weight vector containing orbit distribution information.

10. The apparatus of claim 8, wherein the processor is configured to train coefficients when a weight vector is decomposed into linear combinations of orbit weights at the time of training the orbit-class scores.

11. The apparatus of claim 10, wherein the orbit-class score is limited to positive numbers at the time of training the coefficients.

12. The apparatus of claim 10, wherein the processor is configured to train the coefficients such that differences from the weight vector are reduced by selecting orbit weights one by one.

13. A non-transitory computer readable storage medium storing computer executable instructions, wherein the instructions, when executed by a processor, cause the processor to perform a method of generating explanations for a graph neural network, the method comprising:
preparing the graph neural network that embeds an input graph into a node representation matrix H, and then outputs a result matrix Z in which a score of a specific class for each node is represented corresponding to the node representation matrix using a weight matrix W;
decomposing the weight matrix W into vector products of an orbit weight matrix P containing information on each orbit and an orbit-class score matrix S;
generating a global explanation in which corresponding orbits and graphlets including the corresponding orbits are provided as subgraphs of the input graph in descending order of orbit-class scores indicating contributions of orbits when the graph neural network classifies nodes into a specific class on the basis of results of decomposition;
selecting a specific node among nodes and classifying the selected specific node as the specific class; and
generating a local explanation in which corresponding orbits and graphlets including the corresponding orbits are provided as subgraphs of the input graph in descending order of node-orbit-class scores indicating contributions of nodes when the graph neural network classifies the selected specific node as the specific class on the basis of the results of decomposition.

14. The non-transitory computer readable storage medium of claim 13, wherein the decomposing comprises:
training the orbit weight matrix P using each node embedding vector in the input graph as an input such that presence or absence of a specific orbit for each node is predictable using a vector product of each node embedding vector and an orbit weight vector; and
training orbit-class scores using the trained orbit weight matrix P as an input such that the weight matrix W is able to be restored using a matrix product of the orbit weight matrix P and the orbit-class score matrix S.

15. The non-transitory computer readable storage medium of claim 14, wherein the training of the orbit weight matrix P comprises:
calculating the vector product for all node embedding vectors in the input graph, applying a sigmoid function to the vector product, and training a case in which a specific orbit exists at a corresponding node as 1 and a case in which the specific orbit does not exist at the corresponding node as 0; and
normalizing the trained orbit weight vector in order to obtain an orbit weight vector of a certain size to train a final orbit weight vector containing orbit distribution information.

16. The non-transitory computer readable storage medium of claim 14, wherein the training of the orbit-class scores comprises training coefficients when a weight vector is decomposed into linear combinations of orbit weights.

17. The non-transitory computer readable storage medium of claim 16, wherein the orbit-class score is limited to positive numbers at the time of training the coefficients.

18. The non-transitory computer readable storage medium of claim 16, wherein training is performed such that differences from the weight vector are reduced by selecting orbit weights one by one at the time of training the coefficients.
